(19) United States
(12) Patent Application Publication
(10) Pub. No.: US 2003/0051013 A1
(43) Pub. Date: Mar. 13, 2003

(54) Method for providing a provisioning key for connecting an electronic device to a computer network

(75) Inventors: Bruce Oliver Anthony JR., Pine Island, MN (US); Louis Edward Behrens, Rochester, MN (US); David Joseph Gimpl, Rochester, MN (US); Tammy Lynn Van Hove, Elgin, MN (US)

Correspondence Address: BRACEWELL & PATTERSON, L.L.P., P.O. BOX 969, AUSTIN, TX, 78767-0969, US

(73) Assignee: International Business Machines Corporation, Armonk, NY (US)

(21) Appl. No.: 09/952,073

(22) Filed: Sep. 12, 2001

(51) Int. Cl. G06F 15/177

(52) U.S. Cl. 709/222; 709/220

(57) ABSTRACT

A method for providing a provisioning key for connecting a computer to a computer network is disclosed. Initially, an order for an electronic device, such as a computer or a personal digital assistant, is placed by an user. The electronic device includes a network communication device capable of providing communication between the electronic device and a computer network. During the purchasing process, the user is prompted to answer a few questions. According to the answers given by the user, corresponding provisioning information for the network communication device within the electronic device is then generated. The provisioning information is stored in a portable medium that can be readily recognized by the electronic device. The portable medium is then delivered to the user.

### BACKGROUND OF THE INVENTION

1. Technical Field

The present invention relates to a method for data processing in general, and in particular to a method for connecting an electronic device to a computer network. Still more particularly, the present invention relates to a method for providing a provisioning key for connecting an electronic device to a computer network.

2. Description of the Prior Art

In today's personal computer market, it is still considered “acceptable” to have end users to handle the bulk of network connectivity task for a home computer. Thus, when it comes to network connections, network service providers and/or computer manufacturers may deliver provisioning information to end users in many ways to allow the end users to connect their home computer to a computer network. Provisioning is defined as a myriad of parameters required for an electronic device, such as a computer, to make a successful, sustained, and reliable connection to a computer network. Commonly, network service providers and/or computer manufacturers provide certain standard predetermined provisioning information to an end user, such as a consumer or a paid service person, via a floppy disk or a compact disk (CD). The end user is then required to manually enter connection information, such as dial-in telephone numbers, area code, telephone properties, server/access information, etc., in order to successfully (and correctly) connect the home computer to the computer network.

Another method of delivering provisioning information is the so-called first call home method. In this method, each new computer is set at the factory to allow an end user to call an “800” number from the computer. After a successful telephone connection has been made via a modem in the computer, the new computer downloads the provisioning data to the computer from a database provided by the computer manufacturer. The problem with such method is that the initial “800” number call may fail and the end user is left with little or no other fall back options except retrying on a limited set of backup telephone numbers. Another problem is that for some services, such as digital subscription line (DSL) and a number of wireless connections, no initial call to the “800” number can be made until the provisioning process has been completed.

Consequently, it would be desirable to provide an improved provisioning method for network connection that is transparent to an end user.

### SUMMARY OF THE INVENTION

In accordance with a preferred embodiment of the present invention, an order for an electronic device, such as a computer or a personal digital assistant, is placed by an user. The electronic device includes a network communication device capable of providing communication between the electronic device and a computer network. During the purchasing process, the user is prompted to answer a few questions. According to the answers given by the user, corresponding provisioning information for the network communication device within the electronic device is then generated. The provisioning information is stored in a portable medium that can be readily recognized by the electronic device. The portable medium is then delivered to the user.

All objects, features, and advantages of the present invention will become apparent in the following detailed written description.

### DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a high-level logic flow diagram of a method for providing a provisioning key for connecting a computer to a computer network, in accordance with a preferred embodiment of the present invention; and

FIG. 2 is a block diagram of a computer system in which a preferred embodiment of the present invention is implemented.

### DESCRIPTION OF A PREFERRED EMBODIMENT

As network communication devices (such as cable modem, DSL modem, wireless modem, etc.) for connecting and communicating to a computer network (such as the Internet) become faster, the procedure for configuring those network communication devices also become more complex. The configuration procedure can no longer be completed by simply inputting a userid, a password, and a telephone number but rather some highly technical parameters such as permanent virtual circuit types, modulation types, encapsulation protocols, and/or other concepts that are generally not known to an average computer user. As such, it would not be prudent to expect an average computer user to be able to configure those network communication devices properly. The present invention provides an improved method for end users to configure their complicated network communication devices in a manner that is as simple as inserting a key to unlock a door.

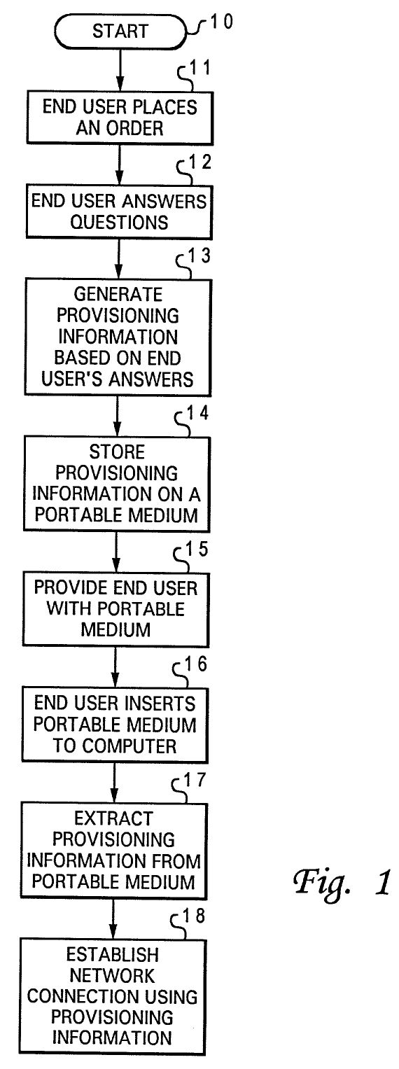

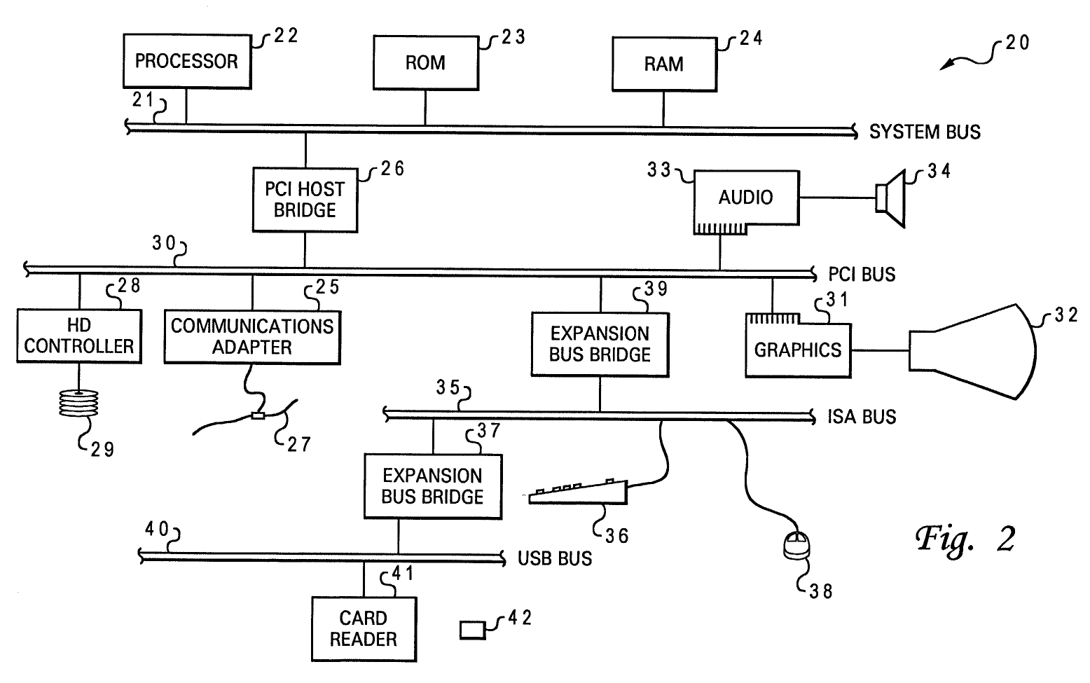

Referring now to the drawings and in particular to FIG. 1, there is depicted a high-level logic flow diagram of a method for providing a provisioning key for connecting a computer to a computer network, in accordance with a preferred embodiment of the present invention. Starting at block 10, a customer (i.e., an end user) places an order for a computer system, as shown in block 11. An example of such computer system is illustrated in FIG. 2, as will be further described in details. During the ordering process, the customer is prompted to answer a few questions that determine the connection provisioning information, as depicted in block 12, and the corresponding provisioning information for a network communication device within the computer are generated based on the answers given by the customer, as illustrated in block 13. For example, based on the home address information provided by the customer, a list of dial-up internet service providers (ISPs) local to the customer's home address is generated, and a list of access numbers to the ISPs may also be generated. The provisioning information is then stored on a portable medium that can be readily recognized by the computer, as shown in block 14. Additional provisioning information may also be separately generated for configuring various types of network communication devices to be used along with the computer system. The portable medium is then delivered to the customer, as depicted in block 15.

Before using the computer for communicating to the computer network, the customer inserts the portable medium to the computer, as illustrated in block 16. At this point, the computer immediately recognizes the provisioning information stored in the portable medium, and begins to load the provisioning information from the portable medium to the computer, as shown in block 17. Subsequently, an application program uses the provisioning information to successfully establish a connection between the computer and the computer network, as depicted in block 18.

Different network communication devices requires different provisioning information. The elements that make up the provisioning information for a dial-up (v.90) connection are as follows:

telephone number <˜20 bytes>

userid password <˜128 bytes>

dialing prefixes <˜10 bytes>

modem commands <˜20 bytes>

The elements that make up the provisioning information for an Ethernet connection are as follows:

type—either Ethernet Version 2 or IEEE 802.3 <1 byte>

method—static or DHCP <1 byte>

if Static, unitIP, gatewayIP, subnetMask, DNS_IP, domain name <272 bytes>

The provisioning information required to facilitate a DSL connection are as follows:

DSL modulation layer <1 byte>

0=full-rate ADSL

1=G-lite ADSL

ATM layer <3 bytes>

Permanent virtual circuit type

Maximum number of permanent virtual circuits

Maximum number of concurrent virtual circuits

for each circuit, the following is specified

VPI—virtual path identifier (0) <4 bytes>

VCI—virtual channel identifier (35) <4 bytes>

ATM class (UBR or CBR) <1 byte>

Encapsulation type <1 byte>

RFC-1483 LLC/SNAP (bridged ip over ATM)

RFC 2364 LLC/SNAP (pppoe—point to point protocol over Ethernet)

RFC-2364 VCMCTX (pppoa—point to point protocol over ATM)

Domain name <maybe up to 256 bytes>

Address assignment (static, dynamic-as in DHCP) <1 byte>

if static, unitIP, gatewayIP, subnetMask, DNS IP <16 bytes>

In accordance with a preferred embodiment of the present invention, a persistent storage device can be used to store an individual end user's provisioning information (the process as depicted in block 14 of FIG. 1). The persistent storage device can store individual end user's connectivity provisioning information that can be readily and transparently used by the end user. The persistent storage device can be automatically read by a computer when inserted into the computer. The persistent device can be a Universal Serial Bus (USB) key device, but a number of different keys are possible, including smart cards, flash based storage devices, and other persistent programmable devices.

With reference to FIG. 2, there is depicted a block diagram of a computer system in which a preferred embodiment of the present invention is implemented. As shown, a computer system 20 includes a processor 22, a read-only memory (ROM) 23, and a random access memory (RAM) 24 connected to a system bus 21. Processor 22, ROM 23, and RAM 24 are also coupled to a peripheral component interconnect (PCI) bus 20 through a PCI host bridge 26. PCI host bridge 26 provides a low latency path through which processor 22 may directly access PCI devices mapped anywhere within bus memory and/or I/O address spaces. PCI host bridge 26 also provides a high bandwidth path allowing PCI devices to directly access RAM 24. In addition, an audio adapter 33 and a graphics adapter 31 may be attached to PCI bus 20. Graphics adapter 31 controls visual output through a video monitor 32 and audio adapter 33 controls audio output through a speaker 24. Also attached to PCI bus 20 is a communication adapter 25 and a hard drive controller 28. Communication adapter 25 connects computer system 20 to a computer network 27, such as an internet or intranet, via a dial-up, Ethernet, or DSL connection. Hard drive controller 28 is utilized to control a hard drive 29.

An expansion bus bridge 39, such as a PCI-to-ISA bus bridge, may be utilized for coupling an industry standard architecture (ISA) bus 35 to PCI bus 30. As shown, a keyboard 36 and a mouse 38 are attached to ISA bus 35 for performing certain basic I/O functions. An expansion bus bridge 37, such as a ISA-to-USB bus bridge, may be utilized for coupling ISA bus 35 to a USB bus 40.

Connected to USB bus 40 is a USB card reader 41 by which a USB card 42 can be read. USB card 42 may be, for example, an “iKey 1000” key manufactured by the Rainbow Technologies Corporation, in which an individual end user's provisioning information is stored. Being a USB device, the iKey 1000 is about 1.5 inches in length and is capable of storing 8 kilobyte worth of data. Another example for USB card 42 that can be used to store an individual end user's provisioning information is a “DiskOnKey” device manufactured by the M-Systems. The DiskOnKey utilizes a standard USB port for instantaneous plug-n-play interoperability on multiple operating systems while without requiring a user to load software drivers. After being inserted into an USB port, the DiskOnKey operates as a secure, reliable, removable hard drive type of device capable of storing up to 32 megabyte of data. The DiskOnKey is an active device with its own processor that is capable of supporting and running multiple applications.

Preferably, USB card 42 is hot-pluggable and the provisioning process is auto-run. Hot-pluggable means USB card 42 may be inserted to or removed from a computer during normal computer operation. Auto-run means the provisioning process is transparent to an end user because the end user does not need to manually run any program to read the provisioning information. Unlike floppy disks, USB card 42 does not cause any interrupts after insertion to USB reader 41, and manual intervention is not required in order to run a program that would then access USB card 42.

As has been described, the present invention provides a method for providing a key-based connectivity provisioning that is transparent to an end user. The advantages of the present invention is that it greatly simplifies the provisioning work for the consumer. The provisioning process for an electronic device, such as an Internet Appliance, becomes a simple, flexible, and inexpensive solution. When the credit card information is being obtained during a purchase, the customer connection requirements can also be collected, for example, via a questionnaire as a part of the purchase process. The collected information is then entered into a database along with the purchase request and a provisioning key is generated based on those information. The provisioning key, in the form of a USB key, would then be sent separately to the end user, ideally, ahead of the product along with germane information on the product, usage, setup, marketing, etc. After the receipt of the product, the end user would then complete the physical connections and uses the USB key to connect the product to a computer network without having to deal with any of the near arcane network required entries.

Although a computer is utilized to illustrate the present invention, it is understood by those skilled in the art that the present invention is applicable to any electronic device, such as a personal digital assistant, Internet appliance, etc., having a network communication device.

While the invention has been particularly shown and described with reference to a preferred embodiment, it will be understood by those skilled in the art that various changes in form and detail may be made therein without departing from the spirit and scope of the invention.

What is claimed is:

1. A method for providing a provisioning key for connecting an electronic device to a computer network, said method comprising:
placing an order for an electronic device by an user, wherein said electronic device includes a network communication device capable of communicating with a computer network;
prompting said user to answer a plurality of questions;
generating corresponding provisioning information for said network communication device within said electronic device based on answers given by said user in response to said plurality of questions;
storing said provisioning information in a portable medium that can be readily recognized by said electronic device; and
delivering said portable medium to said user.

2. The method of claim 1, wherein said questions further includes question that determine the connection provisioning information.

3. The method of claim 1, wherein said questions further includes a home address of said user.

4. The method of claim 1, wherein said questions further includes user environment of said user.

5. The method of claim 1, wherein said electronic device is a computer.

6. The method of claim 1, wherein said electronic device is a personal digital assistant.

7. A method for associating a provisioning key with an electronic device having a network communication device capable of communicating with a computer network, said method comprising:
prompting said user to answer a plurality of questions at the point of sale of said electronic device;
generating corresponding provisioning information for said network communication device within said electronic device based on answers given by said user in response to said plurality of questions;
storing said provisioning information in a portable medium that can be readily recognized by said electronic device; and
delivering said portable medium to said user.

8. The method of claim 7, wherein said questions further includes question that determine the connection provisioning information.

9. The method of claim 7, wherein said questions further includes a home address of said user.

10. The method of claim 7, wherein said questions farther includes user environment of said user.

11. The method of claim 7, wherein said electronic device is a computer.

12. The method of claim 7, wherein said electronic device is a personal digital assistant
